(19) United States
(12) Patent Application Publication
(10) Pub. No.: US 2026/0279071 A1
(43) Pub. Date: Sep. 17, 2026

(54) SYSTEM AND METHOD FOR DETECTING OBJECT IN GENERALIZED WAY BASED ON LIDAR AND ARTIFICIAL INTELLIGENCE

(71) Applicants: HYUNDAI MOTOR COMPANY, Seoul (KR); Kia Corporation, Seoul (KR); Seoul National University R&DB Foundation, Seoul (KR)

(72) Inventors: Ho Tae SEO, Gyeonggido (KR); Jaesik PARK, Seoul (KR); Kwonyoung RYU, Seoul (KR); In-Jae LEE, Seoul (KR)

(21) Appl. No.: 19/371,123

(22) Filed: Oct. 28, 2025

(30) Foreign Application Priority Data
Mar. 13, 2025 (KR) 10-2025-0032847

(51) Int. Cl. G06V 20/58; G01S 17/894; G01S 17/931; G06V 10/82; G06V 20/56; G06V 20/64

(52) U.S. Cl. CPC G06V 20/58; G01S 17/894; G01S 17/931; G06V 10/82; G06V 20/588; G06V 20/647

(57) ABSTRACT

A system for performing artificial-intelligence (AI)-based object recognition using sensor data obtained from a LiDAR sensor. The system includes a processor and a memory storing instructions that, when executed, converts “N” LiDAR points constituting point cloud data into a voxel image including “M” voxels, extracts features for object recognition from the voxel image using a backbone network, generates Bird's Eye View (BEV)-based voxel features from the extracted features, and recognizes an object via an inference network based on voxel-level vision-language embedding features obtained by inputting the BEV-based voxel features into an MLP (Multi-layer Perceptron) neural network with a unified single head.

### CROSS-REFERENCE TO RELATED APPLICATION

Pursuant to 35 U.S.C. § 119(a), this application claims the benefit of an earlier filing date and right of priority to Korean Patent Application No. 10-2025-0032847, filed in the Korean Intellectual Property Office on Mar. 13, 2025, the entire contents of which are incorporated herein by reference.

### TECHNICAL FIELD

The present disclosure relates to object detection based on LiDAR and AI (Artificial Intelligence).

### BACKGROUND

With the recent development and commercialization of autonomous vehicles, there has been a growing number of cases where various sensors and AI (Artificial Intelligence) technologies are used to support autonomous driving functions. For example, ongoing research focuses on recognizing whether any object exists in front of a moving vehicle, estimating the distance between the object and the vehicle, and determining how the vehicle should respond under specific scenarios based on appropriate algorithms to ensure safety.

As a result, vehicle sensor technologies have become more advanced, and high-performance sensors, such as LiDAR (Light Detection and Ranging), which detects the surrounding environment using laser beams, RADAR (Radio Detection and Ranging), which uses radio waves, ultrasonic sensors; fisheye cameras capable of 360-degree video capture, multifocal lenses, and GPS (Global Positioning System) are being increasingly adopted in vehicles.

Also, it has become possible to implement a so-called super sensor vehicle by aggregating measurement results obtained from multiple sensors. In self-driving or autonomous driving, the concept of a super sensor refers to a technology to more accurately recognize the surrounding environment by combining measurements from various sensors rather than relying on individual sensors for driving convenience or safety. With the addition of Information and Communications Technology (ICT) and cloud technology, sensors and related AI algorithms required for autonomous driving are becoming unprecedentedly sophisticated by remotely accumulating data in fleet of vehicles rather than a single vehicle, and training AI servers and databases to increase the reliability of measurements of vehicle sensors.

### SUMMARY

According to a first aspect of the present disclosure, a system for recognizing an object using an AI module and a LiDAR includes a processor including, as part of the AI module, an object recognition module that recognizes an object present in a surrounding environment based on point cloud data input from the LiDAR, and a memory that stores the point cloud data, wherein the AI module executes a first phase of converting “N” LiDAR points constituting the point cloud data into a voxel image including “M” voxels, a second phase of extracting features for object recognition from the voxel image using a backbone network, a third phase of generating Bird's Eye View (BEV)-based voxel features from the extracted features, and a fourth phase of recognizing an object via an inference network based on voxel-level vision-language embedding features, such as CLIP (Contrastive Language-Image Pre-training) features, obtained by inputting the BEV-based voxel features into an MLP (Multi-layer Perceptron) module that includes a unified single head.

According to a second aspect of the present disclosure, the fourth phase may include extracting CLIP features at an image pixel level by inputting an original image corresponding to the point cloud data into a CLIP encoder, and matching the CLIP features at the image pixel level to each LiDAR point of the point cloud data.

According to a third aspect of the present disclosure, when a resolution of the original image is higher than a resolution of the point cloud data, the matching may include associating two or more of the CLIP features at the image pixel level with the each LiDAR point.

According to a fourth aspect of the present disclosure, the matching may be performed by applying convolutional neural network (CNN) computation based on an average pooling technique.

According to a fifth aspect of the present disclosure, the fourth phase may include converting the CLIP features at the image pixel level matched to the each LiDAR point into the voxel CLIP features.

According to a sixth aspect of the present disclosure, a data size of the voxel CLIP (Contrastive Language-Image Pre-training) features input to the inference network may be determined through dimensionality reduction by the MLP (Multi-layer Perceptron) module.

According to a seventh aspect of the present disclosure, the MLP module may include an MLP encoder and an MLP decoder, and when the MLP encoder is included, the MLP encoder may input the voxel CLIP features to the inference network, the MLP encoder being trained to reduce a loss caused by a difference between the data size of the voxel CLIP feature and a data size of the voxel CLIP feature immediately before being input into the inference network.

According to an eighth aspect of the present disclosure, the loss may be quantitatively calculated using a cosine similarity loss function.

According to a ninth aspect of the present disclosure, the loss may be calculated by reflecting calculation result of an L2 loss along with the cosine similarity in a composite manner.

According to a tenth aspect of the present disclosure, the inference network may be a convolutional neural network (CNN) using a 6×6 or 7×7 convolution kernel.

According to an eleventh aspect of the present disclosure, a method for recognizing an object using an AI module and a LiDAR includes a first phase of converting “N” LiDAR points constituting the point cloud data into a voxel image including “M” voxels, a second phase of extracting features for object recognition from the voxel image using a backbone network, a third phase of generating Bird's Eye View (BEV)-based voxel features from the extracted features, and a fourth phase of recognizing an object via an inference network based on voxel-level vision-language embedding features, such as CLIP (Contrastive Language-Image Pre-training) features, obtained by inputting the BEV-based voxel features into an MLP (Multi-layer Perceptron) module that includes a unified single head.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of an overall system for automatically recognizing an object and controlling a vehicle for purposes of autonomous driving, according to an implementation of the present disclosure;

FIG. 2 is a flowchart illustrating an example of the overall configuration of an algorithm applied to object recognition system based on AI and LiDAR according to an implementation of the present disclosure;

FIG. 3 is a block diagram for describing an example of an AI training method proposed according to an implementation of the present disclosure for object recognition based on AI and LiDAR;

FIGS. 4A and 4B are diagrams for describing an example of an operating method of an MLP module according to an implementation of the present disclosure;

FIG. 5 is a block flowchart comprehensively illustrating an example of the inference operation principle of the AI module according to an implementation of the present disclosure;

FIG. 6 shows an example of actual experimental results in which the object recognition technology based on AI and LiDAR, according to an implementation of the present disclosure, is applied; and

FIG. 7 is a block diagram illustrating an example of a computing system for autonomous vehicle control and object recognition computation according to an implementation of the present disclosure.

### DETAILED DESCRIPTION

The present disclosure relates to object detection based on LiDAR and AI (Artificial Intelligence). In some implementations, a LiDAR- and AI-based object recognition system and method can automatically recognize even undefined object classes by integrating various datasets used for AI training and employing an Open Vocabulary Detection (OVD) technique.

In many scenarios, the types of objects present in an environment (e.g., objects on roads during autonomous driving) are extremely diverse. In most AI training for autonomous driving, machine learning is performed by assigning predefined classes to specific objects. Therefore, when an object not included in the training classes appears on the road, the AI system may either fail to recognize it altogether or misclassify it into an incorrect category, leading to potential problems.

Implementations of the present disclosure can provide an object detection system and method based on LiDAR and Artificial Intelligence (AI). For example, a universal object recognition system and method based on LiDAR and AI can integrate various datasets used for AI training, and utilize an Open Vocabulary Detection (OVD) technique to automatically recognize even objects belonging to undefined classes.

As described in the various aspects of the present disclosure, the present disclosure is configured to convert LiDAR point cloud data into a voxel image, generate BEV (Bird's Eye View)-based voxel features from the features extracted by inputting the voxel image into a backbone network, and recognize an object using an inference network that employs, for example, a 6×6 or 7×7 convolution kernel based on voxel CLIP (Contrastive Language-Image Pre-training) features, which are obtained by inputting the voxel features into an MLP (Multi-layer Perceptron) module including a unified single head.

Recently, autonomous driving technology and advanced driver assistance systems (ADAS) utilizing LiDAR have become widely adopted. Unlike traditional camera-based approaches, LiDAR may accurately measure physical distances. In this context, the present disclosure proposes an object recognition technology based on LiDAR and AI. In particular, the present disclosure focuses on the idea that even AI models originally designed for specific tasks is capable of being effectively transferred to serve other purposes.

Thus, the present disclosure implements a general object detection technology that is not limited to the label definitions annotated in a specific dataset. To enable general and universal object recognition without being biased toward specific datasets, the present disclosure proposes a novel P-Box recognition method that recognizes objects from LiDAR point cloud using image and label information, which is achieved by applying a Vision-Language Model (VLM), specifically the Contrastive Language-Image Pre-training (CLIP) model, which enables joint learning of images and text to the field of autonomous driving to train the model with general 3D point cloud features.

In conventional technologies, object detection using LiDAR was only accurate for objects labeled within a predefined dataset, and detection of objects with unlabeled or undefined classes was virtually impossible.

The present disclosure provides a method for detecting objects related to so-called open-set classes from LiDAR point cloud data. That is, the present disclosure is configured to detect objects belonging to classes that were not present in the AI training data, through real-time inference. Therefore, according to the present disclosure, AI may detect objects from datasets that were not pre-learned or that are variably defined.

In particular, the present disclosure performs 3D LiDAR object detection even in the absence of corresponding images by utilizing the Open Vocabulary Detection (OVD) technique and accelerates 3D LiDAR object processing by employing “dimensionality reduction” which is the characteristic of the aforementioned CLIP.

In addition to the effects described above, those skilled in the art will understand that various other advantages may be derived from the detailed description and accompanying drawings of the present disclosure.

Hereinafter, some implementations of the present disclosure will be described in detail with reference to the exemplary drawings. In adding the reference numerals to the components of each drawing, it should be noted that the identical or equivalent component is designated by the identical numeral even when they are displayed on other drawings. Further, in describing the implementation of the present disclosure, a detailed description of well-known features or functions will be ruled out in order not to unnecessarily obscure the gist of the present disclosure.

In describing the components of the implementation according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, in the present disclosure, the term “object” has essentially the same meaning as “entity” and the terms “object” and “entity” will be used interchangeably throughout the description of the disclosure.

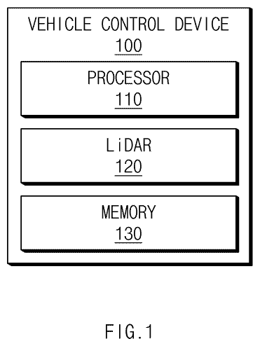

FIG. 1 is a block diagram illustrating an overall system for automatically recognizing an object and controlling a vehicle for purposes of autonomous driving, according to an implementation of the present disclosure.

Referring to FIG. 1, a vehicle control device 100 according to an implementation of the present disclosure may be implemented inside or outside a vehicle, and part of components included in the vehicle control device 100 may be implemented inside or outside the vehicle. In some implementations, the vehicle control device 100 may be integrally formed with internal control units of the vehicle, or may be implemented as a separate device and connected to the control units of the vehicle by separate connection technique. For example, the vehicle control device 100 may further include components not shown in FIG. 1.

The vehicle control device 100 according to an implementation may include a processor 110, a sensor 120, such as LiDAR or other type of sensor, and a memory 130. The processor 110, the sensor 120, or the memory 130 may be electronically and/or operably coupled with each other by an electronical component including a communication bus.

Hereinafter, the operably coupling of hardware may refer, for example, to a direct or indirect connection between hardware being established by wire or wirelessly, such that a second hardware is controlled by a first hardware among the hardware.

The implementations shown in the different blocks of FIG. 1 are not intended to be limiting. For example, a part of the pieces of hardware of FIG. 1 may be included in a single integrated circuit, including a system on a chip (SoC). The types and/or number of pieces of hardware included within the vehicle control device 100 are not limited to those shown in FIG. 1. For example, the vehicle control device 100 may include only a part of the hardware shown in FIG. 1.

The vehicle control device 100 according to an implementation may include hardware for processing data based on one or more instructions. For example, the hardware for processing the data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or the structure of a multi-core processor including dual core, quad core, hexa core, or octa core.

According to an implementation, the processor 110 may include at least one of a graphic processing unit (GPU), or a neural processing unit (NPU), or any combination thereof. For example, the GPU may be referred to as a visual processing unit (VPU). For example, the NPU may be referred to as a neural network processing unit.

According to an implementation, the vehicle control device 100 may include a sensor 120, such as a depth sensor for detecting an external object. For example, the sensor 120 for detecting an external object may include at least one of a time of flight (ToF) sensor, light detection and ranging (LiDAR), a structured light sensor, an ultrasonic sensor, an infrared sensor, a radio detection and ranging (RADAR) sensor, or an optical distance sensor, or any combination thereof. For ease of description, the following discussion will focus on the sensor 120 implemented as LiDAR, although implementations are not limited thereto.

According to an implementation, the vehicle control device 100 may include the LiDAR sensor 120 (or simply referred to as LiDAR 120) that acquires a plurality of points based on a pulsed laser signal. For example, the LiDAR 120 can acquire sets of data identifying a surrounding object of the vehicle control device 100 (or a vehicle including the vehicle control device 100). For example, the LiDAR 120 may identify a position, a movement direction, or a speed of the surrounding object, or any combination thereof based on the pulse laser signal emitted from the LiDAR 120 being reflected and returned to the surrounding object.

For example, the LiDAR 120 may acquire data sets representing an external object in a space formed by the x-axis, the y-axis, and the z-axis based on the pulse laser signal reflected from the surrounding object. For example, the LiDAR 120 may acquire data sets that include a plurality of points in the space formed by the x axis, Y axis, and z axes based on receiving a pulse laser signal at specified intervals. For example, the plurality of points may include points representing an external object within a three-dimensional virtual coordinate system. The three-dimensional virtual coordinate system may include at least one of a vehicle coordinate system, or a LiDAR coordinate system, or any combination thereof. However, examples of three-dimensional virtual coordinate systems are not limited to the above-described coordinate systems.

According to an implementation, the memory 130 of the vehicle control device 100 may include hardware components for storing data and/or instructions that are input to and/or output from the processor 110 of the vehicle control device 100. For example, the memory 130 may include a volatile memory including a random-access memory (RAM), or a non-volatile memory including a read-only memory (ROM).

For example, the volatile memory may include at least one of a dynamic RAM (DRAM), a static RAM (SRAM), a cache RAM or a pseudo SRAM (PSRAM), or any combination thereof. For example, the non-volatile memory may include at least one of a programmable ROM (PRCM)), an erasable PROM (EPROM), an electrically erasable PROM (EEPROM), a flash memory, a hard a disk, compact disc, a solid state drive (SSD) or an embedded multi-media card (eMMC), or any combination thereof.

For example, the memory 130 of the vehicle control device 100 may store one or more instructions (or commands) indicating arithmetic operations and/or operations to be performed on data by the processor 110 of the vehicle control device 100. A set of one or more instructions may be referred to as a program, firmware, an operating system, a process, a routine, a sub-routine, and/or an application.

In the following, an application being installed in the vehicle control device 100 may mean that one or more instructions provided in the form of an application are stored in the memory 130, wherein the one or more applications are stored in an executable format (e.g., a file with an extension specified by the operating system of the vehicle control device 100) by the processor 110 of the vehicle control device 100.

For example, the memory 130 may include a first neural network model for detecting an object. For example, the memory 130 may include a second neural network model for outputting types of the plurality of points acquired by the LiDAR 120, and/or a score of the plurality of points.

In an implementation, the processor 110 may obtain at least one of a first virtual box for representing a target object, or a first class for representing a type of the target object, or any combination thereof, based on the plurality of points obtained by the LiDAR 120 and the first neural network model stored in the memory 130.

For example, based on inputting the plurality of points into the first neural network model, the processor 110 may obtain at least one of the first virtual box for representing the target object or the first class representing the type of the target object, or any combination thereof. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is tracked, e.g., continuously tracked. For example, the type of the target object may include one or more of a plurality of types for categorizing the target object. For example, the type of the target object may include at least one of a first type representing the ground or a second type representing a type different from the ground, or any combination thereof. However, the type of the target object is not limited to the above-described types. For example, the type of the target object may include, but is not limited to, at least one of a third type representing a person or a fourth type representing a vehicle, or any combination thereof.

In an implementation, the processor 110 may obtain, based on the plurality of points and a second neural network model, at least one of a first subset of points (also referred to herein as first sub-points or first part points) corresponding to at least a part of the target object among the plurality of points or a second class identified through the first sub-points and representing the type of the target object, or any combination thereof. For example, the second neural network model may include a segmentation model.

For example, the second neural network model may include a neural network model for obtaining the types of the plurality of points and scores of the plurality of points.

For example, the processor 110 may obtain the first sub-points corresponding to at least a part of the target object among the plurality of points, based on inputting the plurality of points into the second neural network model. For example, the processor 110 may identify the type of the plurality of points based on inputting the plurality of points into the second neural network model. For example, based on the type of each of the plurality of points, the processor 110 may obtain first sub-points that correspond to at least a part of the target object among the plurality of points.

In an implementation, the processor 110 may perform a first specified algorithm on the plurality of points. For example, the processor 110 may perform the first specified algorithm on the plurality of points to classify a type of each of the plurality of points. For example, the processor 110 may classify second sub-points corresponding to a specified type among the plurality of points. For example, the specified type may include a type that represents the ground.

For example, the processor 110 may classify the second sub-points corresponding to the specified type based on performing the first specified algorithm on the plurality of points, and obtain (or identify) the first sub-points by excluding the second sub-points among the plurality of points.

In an implementation, the processor 110 may obtain at least one of a subclass to obtain a second class, or a score for each of the plurality of points, or any combination thereof, based on inputting the plurality of points into the second neural network model. For example, the processor 110 may obtain the subclass, and the score for each of the plurality of points, based on inputting the plurality of points into the second neural network model. For example, the subclass may include categorizing each of the plurality of points into a certain type.

For example, the processor 110 may fuse the subclass, the score of each of the plurality of points, and the second sub-points. For example, the processor 110 may perform clustering based on a fusion of the subclass, the score of each of the plurality of points, and the second sub-points. For example, the clustering may include grouping the first sub-points corresponding to at least a part of the target object.

For example, the processor 110 may obtain a point cloud for generating a second virtual box based on the first sub-points. For example, the processor 110 may obtain a point cloud based on grouping the first sub-points.

For example, the processor 110 may, based on the point cloud, generate a second virtual box for representing the target object that is different from the first virtual box. For example, the second virtual box may include a box that includes at least a part of the first sub-points.

For example, the processor 110 may identify, based on at least one of the first sub-points or the point cloud, or any combination thereof, a heading direction indicative of a direction of movement of the target object.

For example, the processor 110 may identify, based on at least one of the first sub-points or the point cloud, or any combination thereof, a position of the second virtual box in a virtual coordinate system. For example, the processor 110 may identify a size of the second virtual box based on at least one of the first sub-points or the point cloud, or any combination thereof. For example, the processor 110 may identify a second class, based on at least one of the first sub-points or the point cloud, or any combination thereof. For example, the processor 110 may identify at least one of a heading direction indicating the direction of movement of the target object, the position of the second virtual box in the virtual coordinate system, the size of the second virtual box, or the second class, or any combination thereof, based on at least one of the first sub-points or the point cloud, or any combination thereof. For example, the processor 110 may identify the heading direction of a bounding box based on at least one of the first virtual box, the first class, the heading direction of the second virtual box, the position of the second virtual box, the size of the second virtual box, or the second class, or any combination thereof. For example, the processor 110 may identify the position of a bounding box in the virtual coordinate system based on at least one of the first virtual box, the first class, the heading direction of the second virtual box, the position of the second virtual box, the size of the second virtual box, or the second class, or any combination thereof. For example, the processor 110 may obtain a third class representing a type of the target object corresponding to a bounding box, based on at least one of the first virtual box, the first class, the heading direction of the second virtual box, the position of the second virtual box, the size of the second virtual box, or the second class, or any combination thereof. For example, the processor 110 may obtain at least one of the heading direction of the bounding box, the position of the bounding box in the virtual coordinate system, or the third class representing the type of the target object corresponding to the bounding box, or any combination thereof, based on at least one of the first virtual box, the first class, the heading direction of the second virtual box, the position of the second virtual box, the size of the second virtual box, or the second class, or any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box using the second identifier. For example, the processor 110 may track the target object based on identifying a plurality of bounding boxes including the bounding box assigned with the second identifier, from a plurality of frames. For example, in scenarios where the second identifier is assigned to a bounding box corresponding to the target object, the processor 110 can track the target object by identifying the plurality of bounding boxes assigned with the second identifier from the plurality of frames.

In an implementation, the processor 110 can output a bounding box corresponding to the target object based on at least one of the first virtual box, the first class, the first sub-points, or the second class, or any combination thereof. For example, the bounding box may include an example where the target object is represented as a cuboid in a virtual coordinate system.

Below is a brief description of the operations performed by a CPU, GPU, and/or NPU included in the processor 110.

In an implementation, the processor 110 may include at least one of a CPU, a GPU, or an NPU, or any combination thereof. For example, at least one of the GPU or the NPU, or any combination thereof may obtain a first virtual box and a first class based on a first neural network model. For example, at least one of the GPU or the NPU may obtain the first virtual box and the first class. For example, at least one of the GPU or the NPU, or any combination thereof may obtain a sub-class for acquiring a second class and the score of each of the plurality of points based on a second neural network model. For example, at least one of the GPU or the NPU may obtain a sub-class for acquiring a second class and the score of each of the plurality of points based on a second neural network model. For example, the CPU may classify second sub-points corresponding to a specified type among the plurality of points based on performing the first specified algorithm for classifying a type of each of the plurality of points.

As described above, the vehicle control device 100 according to an implementation may include at least one processor 110. The vehicle control device 100 may accurately detect the target object by detecting the target object using at least one processor 110. Additionally, the vehicle control device 100 may reduce the load on each processor by performing parallel processes.

Object recognition is described next, including examples based on specific scenarios. Specifically, a description related to examples of object recognition based on LiDAR is provided below to enhance understanding of the AI-based object recognition of the present disclosure.

In some implementations, the object recognition process using the LiDAR 120 and AI module involves three stages: preprocessing, segmentation, and tracking.

Pre-processing can be performed by the object recognition system 1000, for example prior to executing an object recognition function. The pre-processing may include operations such as removing ground-forming points based on laser sensing data (that is, raw data) input from the LiDAR 120. Because laser beams reflected from the ground may cause misrecognition, making it seem as if there are objects on the ground, the process of distinguishing between ground and non-ground may be performed during the preprocessing stage and, in some scenarios, during the segmentation stage.

In some implementations, preprocessing in AI-based object recognition can include a process in which the image processing tool of the AI module within the processor 110 removes noise from the LiDAR point cloud image and improves computational efficiency by reducing the total number of points in the LiDAR point cloud image, for example, through techniques such as voxel downsampling.

For reference, in some scenarios, LiDAR point cloud images may also be represented in a BEV (Bird's Eye View) format. When a LiDAR map is generated from a top-down perspective-similar to what a bird might see while flying over an urban area, it is referred to as a BEV (Bird's Eye View) image.

As described above, the LiDAR 120 may emit laser beams into surrounding environment, generate a point for each laser signal by recording the time it takes for the laser beam to reflect off an external object and return and then calculate the distance to the point. By repeatedly emitting a large number of laser beams, the processor 110 may generate a real-time LiDAR map of the surrounding environment in a 3D BEV format and, in some scenarios, in a 2D format as well.

The black-and-white lines or surfaces shown on the LiDAR point cloud map can consist of numerous points, each of which is generated by laser beams of the LiDAR 120. For this reason, LiDAR sensing images can be LiDAR point cloud images. In some implementations, when combining RGB-D (Red, Green, Blue—Depth) sensors with LiDAR sensors, the LiDAR point cloud image can be reconstructed in color.

While individual points in the LiDAR point cloud image may not be recognizable to the human eye, a comprehensive view of the point cloud-such as in BEV format or 2D plane-provides a general understanding of what the surrounding environment looks like for the vehicle currently in autonomous operation. Furthermore, it is also possible to recognize objects such as cars, buses, pedestrians, street trees, and traffic signs within a LiDAR point cloud image. In AI-based image recognition, these physical items or people are referred to as “objects,” and each object may be classified into a specific group called a “class,” such as the car class or bus class, depending on its characteristics.

Distinguishing which class an object belongs to, such as whether a particular object in the LiDAR point cloud image is a car or a bus, can be performed with machine-learning techniques, such as a deep neural network. To determine objects within the LiDAR point cloud image and identify their classes using an AI neural network, AI training may need to be performed beforehand.

Such AI training can utilize one or more datasets. For example, the PANDASET™ dataset (source: https://pandaset.org/#data-collection) includes over 48,000 camera images (primarily of the Silicon Valley area in the United States) and over 16,000 LiDAR scan images. These images are annotated with a total of 28 classes, including pedestrians, cars, bicycles, construction site signs, traffic signs and the like.

In addition, the LiDAR point cloud image may be visualized according to user-defined options using point cloud processing tools such as Open3D™ (source: https://www.open3d.org/). Because the LiDAR 120 is able to measure distances, Open3D™ may render 3D LiDAR images more vividly by, for example, displaying distant objects in dark blue and closer objects in light blue.

In addition, in some implementations as discussed above, an original LiDAR image (that is, raw data) can be pre-processed by applying, to the LiDAR point cloud image, a technique known as voxel downsampling. Here, a voxel refers to a cube-shaped 3D unit element, analogous to a 2D pixel. Voxel downsampling can achieve a reduction in the number of points in a point cloud while preserving the structural integrity of various objects within the point cloud to minimize the computational load required for AI processing.

In some implementations, during a single scan cycle, the LiDAR 120 emits, for example, “m” laser beams n times. In this case, the scan values of the laser beams that reflect off external objects can be represented using an (m×n) matrix, which is referred to as a range image. Each point that constitutes the LiDAR point cloud image can include, for example, depth (i.e., range) information, along with additional information such as the intensity, azimuth, and inclination of the reflected laser pulse, and other supplementary data. In some implementations, the range images may be used for AI training with large-scale datasets such as the WOD (Waymo™ Open Dataset).

Range View (RV) is a technique that can represent a 3D point cloud, for example in a LiDAR 3D map, such that it is visualized more intuitively by humans. Range view can convert the 3D point cloud into a 2D, for example, 2.5D scene, similar to an analogue-style image, instead of numerous discrete points. In a range view image, the three-dimensional LiDAR point cloud image has two-dimensional coordinates, but the three-dimensional laser-related information (angle, inclination, intensity, etc.) that was recorded when obtaining the range image earlier may not be discarded. By applying a variable called width to the (x, y) coordinates of (x, y, z) coordinates of a 3D LiDAR image, one axis of the 2D coordinates is obtained and by applying range image information representing a range (depth) and a variable called height to the z-coordinate, the other axis of the 2D coordinates is obtained, resulting in the construction of the 2D range-view image.

In some implementations, the AI algorithm can utilize a CNN (Convolutional Neural Network), for example, as part of an AI training module for extracting features (or keypoints) from image data. The training can utilize datasets containing tens of thousands of images, and the CNNs can be capable of processing 1D to 3D images. The output of the range view image processing tool can be used to train the CNN, which helps the AI accurately recognize objects in the image.

In scenarios where machine-learning is utilized to recognize objects around an autonomous vehicle, the creation of Ground Truth (GT) bounding boxes in the LiDAR map can also be utilized as part of the object recognition process. In machine learning, “ground truth” refers to the original or actual value of data used for AI training. For example, the GT can be represented as a type of image annotation that is annotated on a LiDAR point cloud image, for example, as a bounding box with box-like boundaries.

To recognize an object, the AI module can utilize labels and group various objects. In some implementations, the spacing of 3D data points used to generate ground truth bounding boxes can also be configured. For example, the spacing can be configured such that each ground truth bounding box contains approximately 50 to 1000 cloud points.

In some scenarios, the raw data captured by sensors such as the LiDAR 120 while the vehicle is driving may not contain GT annotations. As such, the processor 110 can recognize various objects or entities as belonging to different classes, such as road signs, crosswalks, pedestrians, other vehicles, and centerlines, etc. Ground truth (GT) annotations can be used to evaluate object recognition errors by comparing determination results of object recognized by the AI algorithm of the processor 110 with actual data, and sometimes to evaluate AI performance. The GT bounding box, which can be added to the original image as annotations, can be set manually by a user, or can be set through GT computation tools such as Grid-striding are also available.

Predicted bounding boxes, in addition to GT bounding boxes, can also be utilized in in AI object recognition. A predictive bounding box can represent a result of what the processor 110 recognizes as an object of a specified class from original image data obtained from the LiDAR sensor 120 or the like. Unlike GT Bounding Boxes, predicted bounding boxes can be the result of the autonomous driving AI's computation. The predicted bounding boxes may match GT bounding boxes, but may not match GT bounding boxes or may not have any overlapping regions with the GT bounding boxes at all.

It is noted that predicted bounding boxes are often referred to as Probability Boxes (P-Boxes) or Predicted Bounding Boxes (PBCs), in scenarios where the predicted bounding boxes do not specify with definitive certainty that an object of a specified class is actually present at a certain location.

Segmentation can be performed, e.g., after preprocessing. Segmentation can involve, for example, marking different parts of the surroundings with different annotations, for example marking a specific part of the road (e.g., a traffic light) in red, while marking the rest (such as the asphalt road) in blue. Clustering point clouds into certain groups and generating P-Boxes can also be performed in the segmentation stage. In some implementations, a technique called Cluster Expansion can be used, in which a cluster is expanded to include additional points within an additional Epsilon distance of a minimum distance from the Seed Point (where the minimum distance defines the unexpanded cluster).

In some implementations, the segmentation process can involve clustering and P-Box generation based on the point cloud. For example, the AI network that performs the segmentation can be used to obtain point labels from the LiDAR sensor 120.

Implementations of the present disclosure can utilize a “Rule-based” ground recognition and label fusion technique. Such techniques can help address problems of ground recognition error during segmentation. For example, in the ground recognition algorithm, any of various techniques can be applied, which can include slope-based ground recognition, grid-based ground recognition, and other non-planar-based ground recognition. However, the present disclosure proposes adopting a slope-based road surface recognition method specifically for recognizing the road surface inside a tunnel.

In some implementations, semantic segmentation can involve assigning a unique class label to each point in the point cloud generated by the LiDAR 120. In LiDAR point cloud image processing technology, semantic segmentation can extract and utilize meaningful information from data obtained by the LiDAR for object recognition or scene reconstruction to implement autonomous driving. Various AI models for semantic segmentation can be used, such as projection-based methods, point-based methods, and sparse convolution-based methods. For example, results of the semantic segmentation may be the outcome of AI computation performed by the processor 110 using the NVIDIA DRIVE™ AGX system. Through such a configuration, various colors may be added to the LiDAR point cloud image.

Post-processing can be performed after the segmentation process. The post-processing can involve converting point cloud data into a three-dimensional map or model that can be meaningful for autonomous driving. The post-processing can also include a process of additionally removing noise or errors in the LiDAR point cloud image, recognizing objects such as vehicles or pedestrians from the point cloud, and, when necessary, assigning unique identifiers to and registering the point cloud data.

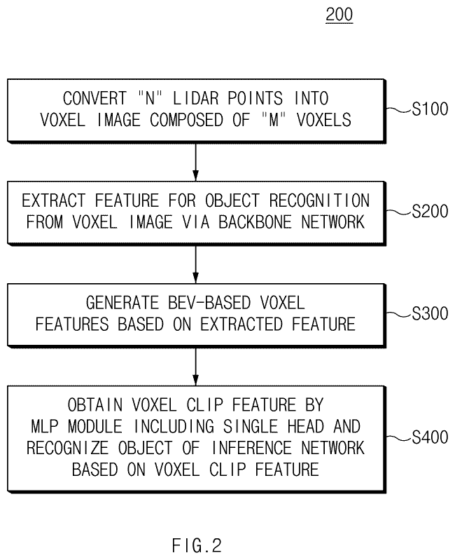

The algorithm of the present disclosure will now be described with reference to FIG. 2. FIG. 2 is a flowchart illustrating an example of the overall configuration of an algorithm applied to a universal object recognition system based on AI and LiDAR according to an implementation of the present disclosure.

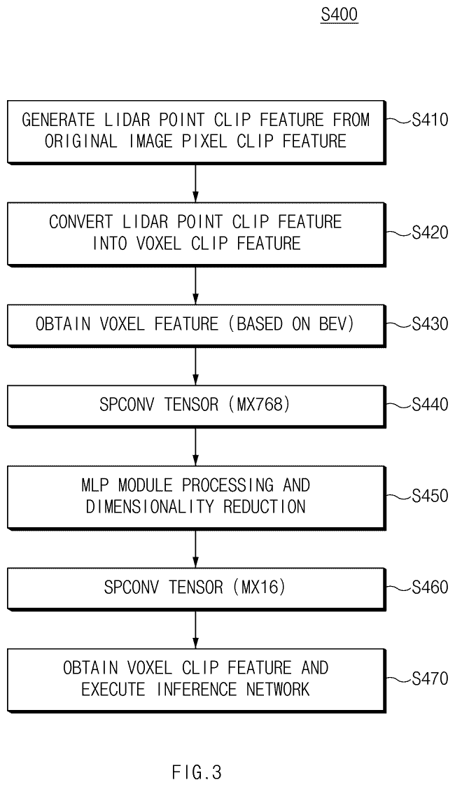

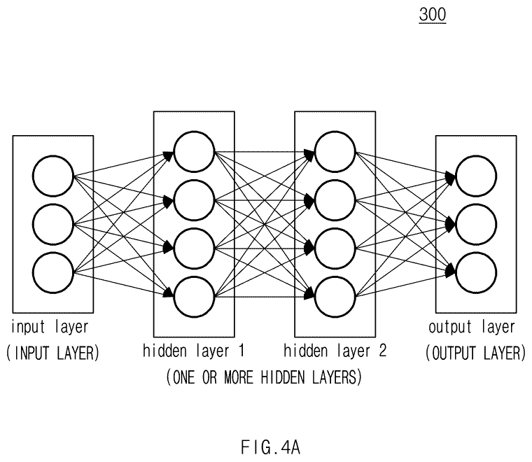

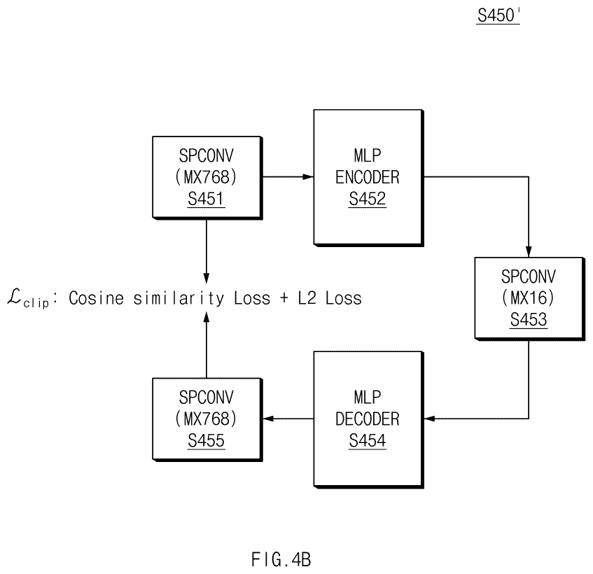

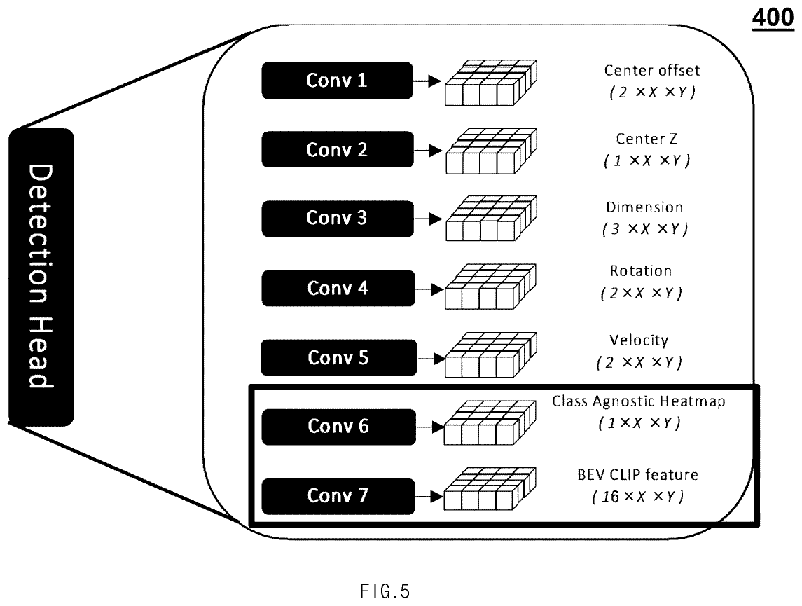

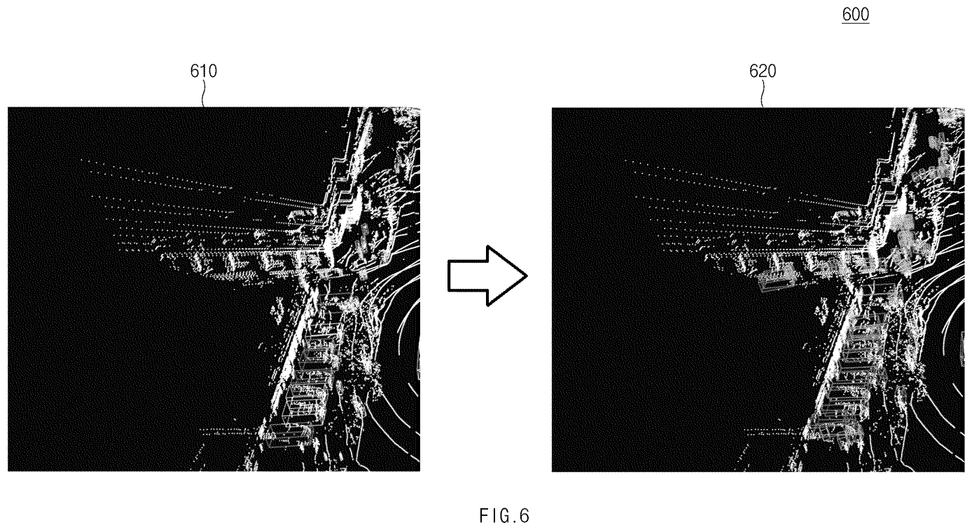

For ease of description and more fulsome understanding, in the course of describing FIG. 2, the different operations of FIG. 2 will be described in conjunction with various references to FIGS. 3 through 6. FIG. 3 is a block diagram of an example for describing an AI training method proposed according to an implementation of the present disclosure for universal object recognition based on AI and LiDAR. FIGS. 4A and 4B are diagrams for describing of an example an operating method of an MLP module according to an implementation of the present disclosure. FIG. 5 is a block flowchart comprehensively illustrating of an example the inference operation principle of the AI module according to an implementation of the present disclosure. FIG. 6 shows of an example actual experimental results in which the universal object recognition technology based on AI and LiDAR, according to an implementation of the present disclosure, is applied.

Referring first to FIG. 2, an algorithm 200 of the present disclosure may operate as part of the AI module installed in the processor 110 of FIG. 1.

In S100, the AI module according to the present disclosure may convert N LiDAR points constituting point cloud data received from the LiDAR 120 into a voxel image composed of M voxels.

As previously described, a voxel may be regarded as a unit element of a three-dimensional image, often referred to as a 3D pixel. When the numerous N points recognized by the LiDAR 120 are mapped into voxels of a fixed volume, a voxel image composed of M voxel pixels, e.g., where M is smaller than N, can be obtained.

In S200, features for object recognition may be extracted from the voxel image obtained in S100, e.g., via a backbone network. The backbone network will be described below. AI-based object recognition systems according to some implementations of the present disclosure can generally include two main parts: the backbone and the head.

The backbone may transform an input image into a feature map that is a map composed of features (e.g., values extracted by an AI machine from an image given for object recognition). An example of the backbone is VGG16, a CNN (Convolutional Neural Network) model with 16 layers, pre-trained with datasets such as ImageNet™ (source: https://www.image-net.org/).

The head can execute AI predictions on object classes using the feature map extracted by the backbone network, and accordingly output the previously-described P-Box. In some implementations, the head may perform dense prediction to determine a class and output predicted bounding boxes (P-Boxes) in a one-stage architecture such as YOLO™ (source: https://pjreddie.com/darknet/yolo/). In a two-stage architecture, the head may perform dense prediction followed by sparse prediction. An example of a two-stage prediction architecture is R-FCN (Object Detection via Region-based Fully Convolutional Networks).

In S300, the features (or feature map) extracted in S200 are converted into voxel features based on BEV (Bird's Eye View). Since the BEV image has already been described previously, a redundant description will be omitted.

In S400, the AI module according to an implementation of the present disclosure may recognize objects through an inference network. The inference network can utilize a pre-trained vision-language machine-learning model that has been trained to learn a correspondence between natural language and images. In some implementations, the pre-trained vision-language model can enable zero- and few-shot detection capability, thus facilitating detection of previously unseen object classes. The vision-language (VL) model can take as input the voxel features from S300 and generate voxel VL features. The voxel VL features can be embedded with information about the relationship between text and images. For example, the vision-language model can be based on Contrastive Language-Image Pre-training (CLIP), and can generate voxel CLIP features. The voxel CLIP features can be obtained, for example, by inputting the voxel features obtained in S300 into an MLP (Multi-layer Perceptron) (e.g., MLP 300 in FIG. 4A) module that includes a unified single head.

Further supplementary descriptions are provided next. First, the single head mechanism described above can provide various advantages over multi-head systems. For example, in alternative systems, separate heads may be used to compute each class, such as car, pedestrian, and various other classes as illustrated in TensorFlow. By contrast, while alternative technologies employ separate heads for each class, implementations of the present disclosure can use a single head.

As described earlier, the present disclosure relates to a technique that enables universal object recognition. Therefore, in some implementations, the classes to be inferred by the AI module are not predefined individually, which can make it impractical to design a separate head for each class, and separate heads may not provide any particular technical advantage within some contexts of the present disclosure.

The MLP (Multi-Layer Perceptron) 300 (see FIG. 4A) in S400 can be, for example, a type of artificial neural network used for supervised learning. The MLP can include at least one nonlinear hidden layer, which can help extract complex patterns from the data being learned. The MLP can be composed of an input layer, one or more hidden layers, and an output layer. Each layer consists of nodes, and the multiple nodes are fully connected to the nodes in the next layer. The MLP can therefore implement “depth” or “layers,” which increases the number of nodes and the complexity of connections, which are used for learning complex patterns.

In some implementations, the pre-trained vision-language model, e.g., which can be based on CLIP (Contrastive Language-Image Pre-training) model, combines a ViT (Vision Transformer) and a transformer-based language model, enabling processing of both images and text. In some scenarios, the ViT enables a transformer, which is formed to extract features from images through unsupervised learning, to process images in the forms of patches.

For example, when natural language is input into the CLIP model, the CLIP model may convert the natural language into an embedding, e.g., by extracting, from language, numerical vectors that an AI machine is able to compute. The CLIP model can use the embedding to generate a matrix of values, e.g., a 77×768 matrix of numerical values, which may then be used to process images accordingly. For example, the value 768 in the size of the matrix can be calculated as follows: the CLIP's ViT may convert an image of 224×224 pixels into patches of 16×16 pixels. Because each patch includes RGB color channels, the dimensionality becomes 16×16×3=768 in this example. For reference, it is also important to understand the term “tensor.” The tensor is an algebraic object that describes multi-linear relationships among multiple algebraic objects associated with a single vector space.

Further description regarding the obtaining of vision-language embedding features in S400 is provided with reference to FIGS. 3 through 6.

Referring to FIG. 3, in S410, an original image corresponding to point cloud data (for example, a 2D color image of a road scene captured by a camera) can be input into a vision-language encoder to extract vision-language embedding features. For example, a CLIP encoder can be used to extract CLIP features at the pixel level.

In S420, the vision-language embedding features, e.g., pixel-level CLIP features, of the image may be matched to each LiDAR point (i.e., N points) of the LiDAR point cloud data. It should be noted that, in most cases, the resolution of the original image is higher than the resolution of the point cloud data. Thus, the “matching” in S420 may involve assigning two or more pixel-level CLIP features to a single LiDAR point.

Further, implementations of the present disclosure can utilize a Convolutional Neural Network (CNN) computation based on the average pooling technique during the above-described matching process. For example, in S420, image pixel CLIP features can be matched to each LiDAR point by utilizing the LiDAR point cloud and the calibration information of the image. In some scenarios, the resolution of the original image is much higher than that of the LiDAR, and in such scenarios, implementations of the present disclosure can determine that matching multiple image pixels to a single LiDAR point is advantageous in terms of preserving information. In some implementations, multiple pixel-level CLIP features are matched to a single LiDAR point through average pooling.

For reference, pooling is a process that can summarize the features of a given image, and can reduce the dimensionality of data that an AI neural network needs to process. The average pooling may refer to computing the average of pooled filter values obtained from each view of an image.

Continuing with reference to FIG. 3, in S430, the vision-language embedding features, e.g., CLIP features at the image pixel level matched to each LiDAR point as described above, are converted into voxel-level vision-language embedding features, e.g., voxel CLIP features (M in total) (i.e., from the BEV perspective).

In S440, sparse tensors, such as an SPCONV TENSOR, can be obtained. In the example where the number of voxels is M and the significance of the number 768 was previously described, the total number of SPCONV tensors obtained in S440 becomes M×768. For reference, the encoded SPCONV tensor may represent a 3D feature volume obtained by a point cloud encoder. “SPCONV” stands for Spatial Sparse Convolution. Because the concepts of tensors and sparse prediction have already been described earlier, redundant description is omitted here. For reference, the SPCONV tensor stores the positions of the M voxels in the BEV space. This is related to the subsequent reduction into the form of BEV CLIP features.

In S450, the data size of the voxel-level vision-language embedding features, e.g., voxel-level CLIP features, fed into an inference network 400 (see FIG. 5), is reduced through dimensionality reduction by the MLP (Multi-layer Perceptron) module.

In S450, the feature map extracted during BEV CLIP feature extraction can be used as a learning target for the inference network 400 (see FIG. 5). For example, when the dimensionality of this feature map is large, the amount of data to be processed by the inference network 400 may become excessive, in which case dimensionality reduction by S450 can provide technical benefits.

However, as shown in S460 of FIG. 3, when the dimensionality is reduced to 16 channels or less, there is a risk of significant information loss. Therefore, the results obtained in S460 may be, for example, the SPCONV tensor with dimensions of M×16.

In summary, S440 through S460 can involve converting the BEV features (width×height×768) into a two-dimensional tensor (M×768) by arranging only M voxels that contain points in a linear fashion in consideration of sparsity, performing dimensionality reduction (i.e., M×16) through the MLP module and restoring the M voxels back into BEV features (width×height×16).

FIG. 4A is a schematic diagram illustrating an example of the MLP module or network 300 described above. As previously mentioned, the MLP module may include three-stage layers: an input layer, hidden layers, and an output layer. When there were no hidden layers, input values would be output as they are, so that the presence of hidden layers with numerous nodes is crucial in the MLP 300 and these nodes are fully connected, as previously discussed.

FIG. 4B shows an example of the training method for the MLP module 300. For example, the MLP encoder shown in S452 primarily performs the operation described in S450. To this end, implementations of the present disclosure can apply the training process as illustrated in FIG. 4B to the MLP 300 prior to executing S450 through the MLP encoder. Although FIG. 4B corresponds to S450, considering that FIG. 4B represents a preliminary training phase for executing S450, it will be referred to as S450′.

In S450′, the MLP 300 can receive the sparse tensor, e.g., SPCONV tensor, with M×768 as an example input in S451. In S452, the SPCONV tensor may be compressed by the MLP encoder, and the result of the compression may be output in S453 as the SPCONV tensor with M×16. In some implementations, the system can restore the output of S453 back to the same size as the tensor before dimensionality reduction using the MLP decoder in S454, which corresponds to S455.

In S456, loss computation is performed using a loss function, such as a cosine similarity loss function, or an L2 loss function, or a combination of both the functions to evaluate the difference between the results of S451 and S455. In S450′, S451 through S456 may be iteratively repeated until the loss is minimized. For example, S450′ can involve performing the training process to minimize the difference between the tensor before dimensionality reduction and the tensor restored through the encoder and decoder. In S450′, both the MLP encoder and the MLP decoder can be trained simultaneously; however, for object recognition in the inference network 400 described in S400, only the MLP encoder can be utilized after extracting the BEV CLIP features.

In some implementations, the inference network 400 applied in S400 (see FIG. 5) can be, for example, a convolutional neural network (CNN) that uses a 6×6 or 7×7 convolution kernel. For convenience, the CNN is referred to herein as CONV6 or CONV7. For reference, the convolution kernel may refer to a filter matrix structure used for feature extraction.

FIG. 5 is a diagram describing an example of inference operation performed in S400.

As shown in FIG. 5, implementations of the present disclosure can implement a single-head structure, unlike alternative techniques that use a separate head for each class. In particular, in some scenarios of universal object recognition according to implementations of the present disclosure, the classes to be inferred are not predefined, in which case it is not feasible to design a head for each class.

For example, the information output of the CONV6 shown in FIG. 5 can be converted into a class-agnostic heatmap according to implementations the present disclosure. By using only a single head, the information contained in the CONV6 heatmap can represent class-independent confidence or probability related to object classification, such as information about the presence or absence of an object.

Furthermore, as illustrated in FIG. 5, implementations of the present disclosure can output class information through CONV7 and enable the inference of classes that are not included in the training data (e.g., CONV7 output can represent class information for each BEV grid). The reason why the CONV7 output is referred to as BEV CLIP features is that the CLIP feature information is used during the training process.

For reference, in FIG. 5, CONV1 through CONV5 may be used to extract information such as the position, size, heading, and velocity of the P-Box for each BEV grid. In addition, implementations of the present disclosure further utilize the CONV6 and CONV7 networks.

FIG. 6 shows an example of actual application results 600 of an AI recognition system according to the present disclosure. Reference numeral 610 represents an object recognition result before applying implementations of the present disclosure. According to the result 610, the GT (ground truth) may correspond to objects of the Car, Pedestrian, and Others classes.

In contrast, the result 620 is a result of implementations of the present disclosure, and shows that the system successfully infers classes that were not included in the training dataset (i.e., Van and Truck in FIG. 6) after being trained with data containing the GT. The corresponding text query used for this inference was “a {Car, Truck, Van, Pedestrian} in a scene.”

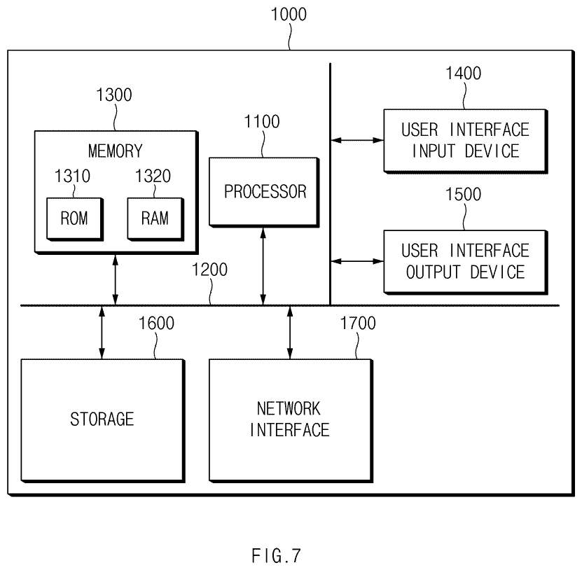

FIG. 7 is a block diagram illustrating an example of a computing system 1000 for autonomous vehicle control and object recognition computation according to an implementation of the present disclosure.

Referring to FIG. 7, the computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the implementations disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the implementation disclosed in the present disclosure is not intended to limit the technical idea of the present disclosure but to describe the present disclosure, and the scope of the technical idea of the present disclosure is not limited by the implementation. The scope of protection of the present disclosure should be interpreted by the following claims, and all technical ideas within the scope equivalent thereto should be construed as being included in the scope of the present disclosure.

Hereinabove, although the present disclosure has been described with reference to exemplary implementations and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system configured to perform artificial-intelligence (AI)-based object recognition using a LiDAR sensor, the system comprising:
at least one processor; and
at least one memory storing computer program instructions that, based on being executed by the at least one processor, perform artificial intelligence (AI)-based operations of object recognition for a surrounding environment based on sensor data obtained from the LiDAR sensor, the operations comprising:
detecting point cloud data from the sensor data obtained from the LiDAR sensor;
converting “N” (N is a natural number) LiDAR points in the point cloud data into a voxel image including “M” (M is a natural number) voxels;
extracting features for object recognition from the voxel image;
generating Bird's Eye View (BEV)-based voxel features from the extracted features;
generating voxel-level vision-language embedding features by inputting the BEV-based voxel features into a Multi-layer Perceptron (MLP) neural network with a unified single head, wherein the voxel-level vision-language embedding features are obtained based on a pre-trained vision-language model; and
performing object recognition based on the voxel-level vision-language embedding features.

2. The system of claim 1, wherein the generating of the voxel-level vision-language embedding features includes:
extracting first vision-language embedding features at an image pixel level by inputting an original image corresponding to the point cloud data into a pre-trained vision-language encoder; and
matching the first vision-language embedding features at the image pixel level to each LiDAR point of the point cloud data.

3. The system of claim 2, wherein, based on a resolution of the original image being higher than a resolution of the point cloud data, the matching includes associating two or more of the first vision-language embedding features at the image pixel level with the each LiDAR point.

4. The system of claim 3, wherein the matching comprises applying convolutional neural network (CNN) computation based on an average pooling technique.

5. The system of claim 2, wherein the generating of the voxel-level vision-language embedding features includes converting the first vision-language embedding features at the image pixel level into a voxel-level, to generate the voxel-level vision-language embedding features.

6. The system of claim 1, wherein a data size of the voxel-level vision-language embedding features is determined through dimensionality reduction by the MLP (Multi-layer Perceptron) neural network.

7. The system of claim 6, wherein the MLP neural network includes an MLP encoder neural network and an MLP decoder neural network,
wherein the MLP encoder neural network is configured to input the voxel-level vision-language embedding features to an inference network, and the MLP encoder is pre-trained to reduce a loss caused by a difference between the voxel-level vision-language embedding features and the voxel-level vision-language embedding feature immediately before being input into the inference network.

8. The system of claim 7, wherein the loss is quantitatively determined based on a cosine similarity loss function.

9. The system of claim 8, wherein the loss is determined based on a composite loss function including an L2 loss and the cosine similarity.

10. The system of claim 7, wherein the inference network comprises a convolutional neural network (CNN) using a 6×6 or 7×7 convolution kernel, and
wherein the voxel-level vision-language embedding features comprise voxel-level Contrastive Language-Image Pre-training (CLIP) features.

11. A method for performing artificial intelligence (AI)-based object recognition using sensor data obtained from a LiDAR sensor, the method comprising:
detecting point cloud data from the sensor data obtained from the LiDAR sensor;
converting “N” (N is a natural number) LiDAR points in the point cloud data into a voxel image including “M” (M is a natural number) voxels;
extracting features for object recognition from the voxel image;
generating Bird's Eye View (BEV)-based voxel features from the extracted features;
generating voxel-level vision-language embedding features by inputting the BEV-based voxel features into a Multi-layer Perceptron (MLP) neural network with a unified single head, wherein the voxel-level vision-language embedding features are obtained based on a pre-trained vision-language model; and
performing object recognition based on the voxel-level vision-language embedding features.

12. The method of claim 11, wherein the generating of the voxel-level vision-language embedding features includes:
extracting first vision-language embedding features at an image pixel level by inputting an original image corresponding to the point cloud data into a pre-trained vision-language encoder; and
matching the first vision-language embedding features at the image pixel level to each LiDAR point of the point cloud data.

13. The method of claim 12, wherein, based on a resolution of the original image being higher than a resolution of the point cloud data, the matching includes associating two or more of the first vision-language embedding features at the image pixel level with the each LiDAR point.

14. The method of claim 13, wherein the matching comprises applying convolutional neural network (CNN) computation based on an average pooling technique.

15. The method of claim 12, wherein the generating of the voxel-level vision-language embedding features includes converting the first vision-language embedding features at the image pixel level into a voxel-level, to generate the voxel-level vision-language embedding features.

16. The method of claim 11, wherein a data size of the voxel-level vision-language embedding features is determined through dimensionality reduction by the MLP (Multi-layer Perceptron) neural network.

17. The method of claim 16, wherein the MLP neural network includes an MLP encoder neural network and an MLP decoder neural network,
wherein the MLP encoder neural network is configured to input the voxel-level vision-language embedding features to an inference network, and the MLP encoder is pre-trained to reduce a loss caused by a difference between the voxel-level vision-language embedding features and the voxel-level vision-language embedding feature immediately before being input into the inference network.

18. The method of claim 17, wherein the loss is quantitatively determined based on a cosine similarity loss function.

19. The method of claim 18, wherein the loss is determined based on a composite loss function including an L2 loss and the cosine similarity.

20. The method of claim 17, wherein the inference network comprises a convolutional neural network (CNN) using a 6×6 or 7×7 convolution kernel, and
wherein the voxel-level vision-language embedding features comprise voxel-level Contrastive Language-Image Pre-training (CLIP) features.
